(19) United States
(12) Patent Application Publication
(10) Pub. No.: US 2025/0211315 A1
(43) Pub. Date: Jun. 26, 2025

(54) HIGH-ISOLATION DUAL-FEED ANTENNA INTEGRATED STEERING SYSTEM

(71) Applicant: Intel Corporation, Santa Clara, CA (US)

(72) Inventors: Oren Ezra Avraham, Givat Shmuel (IL); Noam Kogos, Ramat Hasharon M (IL); Seong-Youp John Suh, Portland, OR (US); Tae Young Yang, Portland, OR (US); Ofir Degani, Haifa (IL)

(21) Appl. No.: 18/390,198

(22) Filed: Dec. 20, 2023

(51) Int. Cl. H04B 7/08; H04B 1/40

(52) U.S. Cl. CPC H04B 7/0802; H04B 1/40

(57) ABSTRACT

A mobile device comprising multi-feed antennas having high feed-to-feed isolation and high antenna-to-antenna isolation. RF transceiver circuitry can couple to the antennas through passive elements to form RF chains. Connectivity circuitry coupled to the RF circuitry can detect communication-related data and perform antenna control functions based on the communication-related data by providing a digital control signal to modify magnitude and phase of the RF chains. No separate antenna controls, apart from the connectivity circuitry, is provided in the mobile device.

### TECHNICAL FIELD

Aspects of the disclosure pertain to radio frequency (RF) communications. More particularly, aspects relate to antenna systems for RF communications.

### BACKGROUND

Modern mobile devices are expected to transmit and receive large amounts of data while on the move. As device expectations increase, many devices are expected to receive and transmit various different types of signals simultaneously. To do this, devices include multiple antenna systems for communication using multiple technologies. Isolation and other parameters can become important to device operation in devices with multiple antenna systems.

### BRIEF DESCRIPTION OF THE DRAWINGS

In the drawings, which are not necessarily drawn to scale, like numerals may describe similar components in different views. Like numerals having different letter suffixes may represent different instances of similar components. Some aspects are illustrated by way of example, and not limitation, in the figures of the accompanying drawings in which:

FIG. 1 illustrates an exemplary user device according to some aspects.

FIG. 2A illustrates exemplary wireless communication circuitry according to some aspects.

FIG. 2B illustrates aspects of exemplary transmit circuitry illustrated in FIG. 2A according to some aspects.

FIG. 2C illustrates aspects of exemplary transmit circuitry illustrated in FIG. 2A according to some aspects.

FIG. 2D illustrates aspects of exemplary radio frequency circuitry illustrated in FIG. 2A according to some aspects.

FIG. 3 illustrates exemplary useable RF circuitry in FIG. 2A according to some aspects.

FIG. 4A illustrates an aspect of an exemplary radio front end module (RFEM) according to some aspects.

FIG. 4B illustrates an alternate aspect of an exemplary radio front end module, according to some aspects.

FIG. 5A is a block diagram of an antenna control system.

FIG. 5B is a block diagram of an antenna control system according to some aspects.

FIG. 6 illustrates spatial diversity and pattern diversity according to some aspects.

FIG. 7 illustrates a block diagram of a communication device such as an evolved Node-B (eNB), a new generation Node-B (gNB), an access point (AP), a wireless station (STA), a mobile station (MS), or a user equipment (UE), in accordance with some aspects.

FIG. 8 illustrates a system level diagram, depicting an example of an electronic device (e.g., system) that can include, for example, a transmitter configured to selectively fan out a signal to one of multiple communication channels.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

Modern mobile and personal computing devices transmit and receive larger amounts of data, and often these devices are called upon to receive and transmit various signals, including signals of different types, simultaneously. To do this, these devices include multiple antenna systems for communication on a variety of radio access technologies (RATs).

Current configurations involving a plurality of antenna systems can suffer from problems such as interference between antennas, compatibility issues within, e.g., radio modems, and other issues. One solution to this problem provides a separate antenna control circuitry to direct antenna operations. However, such solutions are expensive at least due to the need to include additional control circuitry. Furthermore, these controllers do not have access to some communications information (such as data regarding conditions) and therefore the controllers may not control antennas optimally to account for this information.

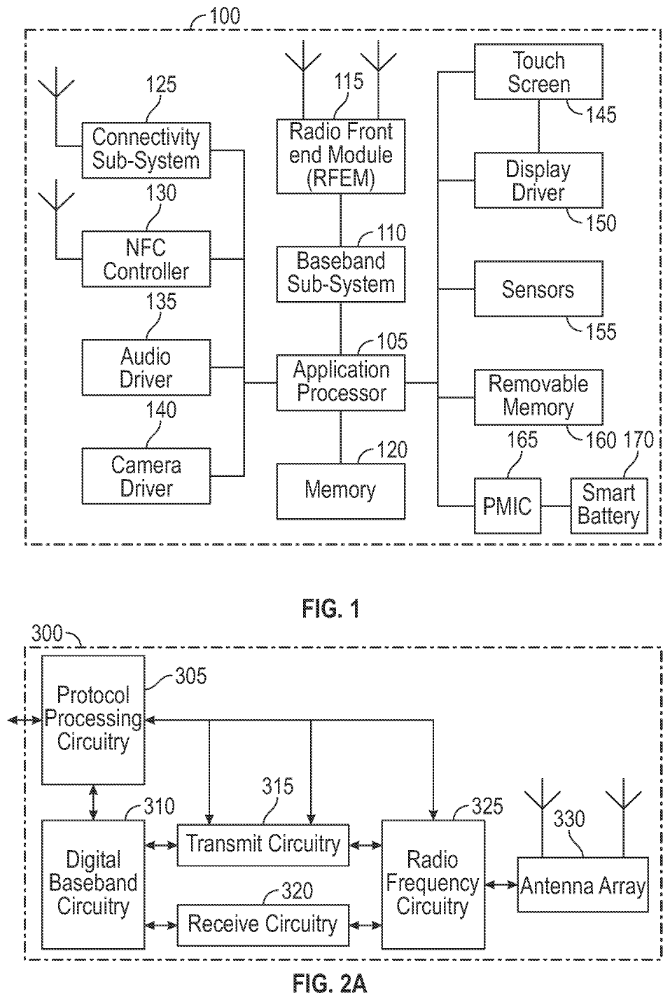

Aspects of the disclosure address these and other concerns by providing dual-feed antenna systems with high antenna-to-antenna isolation spaced to guarantee high isolation. Control (e.g., steering, nulling, weighting, etc.) is provided by circuitry, already present in most or all communication systems, which can detect communications interface conditions and other parameters to control the antenna/s as described later herein. The communication systems, devices, and other components providing these antenna systems are described in more detail with respect to FIG. 1-4.

An integrated Radio-Frequency frontend module (FEM) is broadly used in the frontend circuits for cellular handsets or other wireless devices. FIG. 1 illustrates an exemplary user device according to some aspects. The user device 100 may be a mobile device in some aspects and includes an application processor 105, base-band processor 110 (also referred to as a base-band sub-system), radio front end module (RFEM) 115, memory 120, connectivity sub-system 125, near field communication (NFC) controller 130, audio driver 135, camera driver 140, touch screen 145, display driver 150, sensors 155, removable memory 160, power management integrated circuit (PMIC) 165, and smart battery 170.

In some aspects, application processor 105 may include, for example, one or more central processing unit (CPU) cores and one or more of cache memory, low drop-out voltage regulators (LDOs), interrupt controllers, serial interfaces such as serial peripheral interface (SPI), inter-integrated circuit (I2C) or universal programmable serial interface sub-system, real time clock (RTC), timer-counters including interval and watchdog timers, general purpose 10, memory card controllers such as SD/MMC or similar, USB interfaces, mobile industry processor interface (MIPI) interfaces, and/or Joint Test Access Group (JTAG) test access ports.

In some aspects, base-band processor 110 may be implemented, for example, as a solder-down substrate including one or more integrated circuits, a single packaged integrated circuit soldered to a main circuit board, and/or a multi-chip module including two or more integrated circuits.

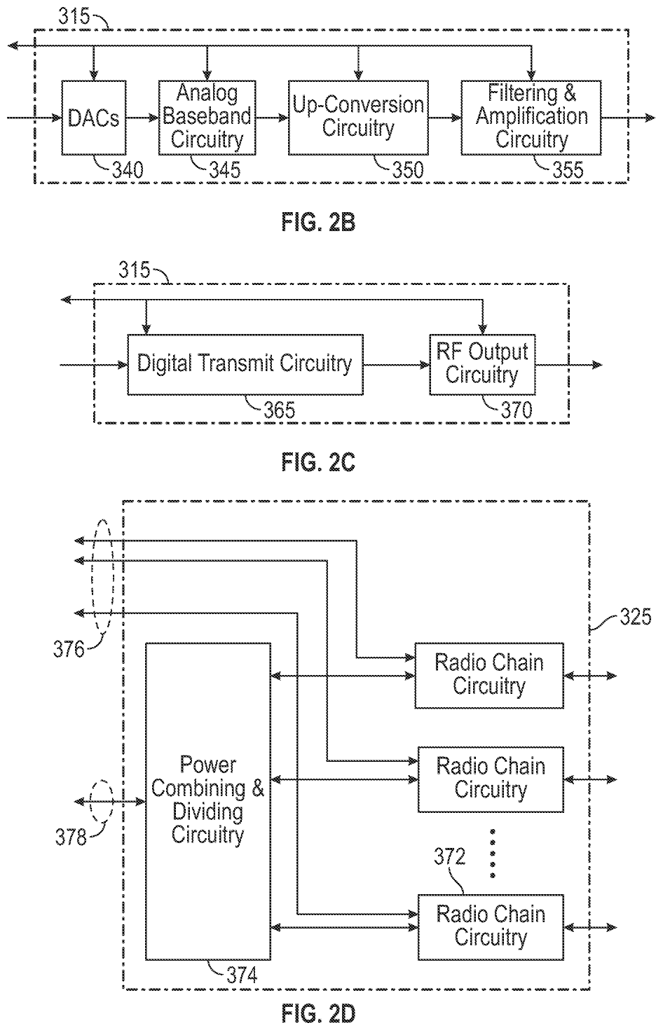

FIG. 2A illustrates exemplary wireless communication circuitry according to some aspects; FIGS. 2B and 2C illustrate aspects of transmit circuitry shown in FIG. 2A according to some aspects; FIG. 2D illustrates aspects of radio frequency circuitry shown in FIG. 2A according to some aspects; Wireless communication circuitry 300 shown in FIG. 2A may be alternatively grouped according to functions. Components illustrated in FIG. 2A are provided here for illustrative purposes and may include other components not shown in FIG. 2A.

Wireless communication circuitry 300 may include protocol processing circuitry 305 (or processor) or other means for processing. Protocol processing circuitry 305 may implement one or more of medium access control (MAC), radio link control (RLC), packet data convergence protocol (PDCP), radio resource control (RRC) and non-access stratum (NAS) functions, among others. Protocol processing circuitry 305 may include one or more processing cores to execute instructions and one or more memory structures to store program and data information.

Wireless communication circuitry 300 may further include digital base-band circuitry 310. Digital base-band circuitry 310 may implement physical layer (PHY) functions including one or more of hybrid automatic repeat request (HARQ) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

Wireless communication circuitry 300 may further include transmit circuitry 315, receive circuitry 320 and/or antenna array circuitry 330. Wireless communication circuitry 300 may further include RF circuitry 325. In some aspects, RF circuitry 325 may include one or multiple parallel RF chains for transmission and/or reception. Each of the RF chains may be connected to one or more antennas of antenna array circuitry 330.

In some aspects, protocol processing circuitry 305 may include one or more instances of control circuitry. The control circuitry may provide control functions for one or more of digital base-band circuitry 310, transmit circuitry 315, receive circuitry 320, and/or RF circuitry 325.

FIGS. 2B and 2C illustrate aspects of transmit circuitry shown in FIG. 2A according to some aspects. Transmit circuitry 315 shown in FIG. 2B may include one or more of digital to analog converters (DACs) 340, analog base-band circuitry 345, up-conversion circuitry 350 and/or filtering and amplification circuitry 355. DACs 340 may convert digital signals into analog signals. Analog base-band circuitry 345 may perform multiple functions as indicated below. Up-conversion circuitry 350 may up-convert base-band signals from analog base-band circuitry 345 to RF frequencies (e.g., mmWave frequencies). Filtering and amplification circuitry 355 may filter and amplify analog signals. Control signals may be supplied between protocol processing circuitry 305 and one or more of DACs 340, analog base-band circuitry 345, up-conversion circuitry 350 and/or filtering and amplification circuitry 355.

Transmit circuitry 315 shown in FIG. 2C may include digital transmit circuitry 365 and RF circuitry 370. In some aspects, signals from filtering and amplification circuitry 355 may be provided to digital transmit circuitry 365. As above, control signals may be supplied between protocol processing circuitry 305 and one or more of digital transmit circuitry 365 and RF circuitry 370.

FIG. 2D illustrates aspects of radio frequency circuitry shown in FIG. 2A according to some aspects. Radio frequency circuitry 325 may include one or more instances of radio chain circuitry 372, which in some aspects may include one or more filters, power amplifiers, low noise amplifiers, programmable phase shifters and power supplies.

Radio frequency circuitry 325 may also in some aspects include power combining and dividing circuitry 374. In some aspects, power combining and dividing circuitry 374 may operate bidirectionally, such that the same physical circuitry may be configured to operate as a power divider when the device is transmitting, and as a power combiner when the device is receiving. In some aspects, power combining and dividing circuitry 374 may include one or more wholly or partially separate circuitries to perform power dividing when the device is transmitting and power combining when the device is receiving. In some aspects, power combining and dividing circuitry 374 may include passive circuitry including one or more two-way power divider/combiners arranged in a tree. In some aspects, power combining and dividing circuitry 374 may include active circuitry including amplifier circuits.

In some aspects, radio frequency circuitry 325 may connect to transmit circuitry 315 and receive circuitry 320 in FIG. 2A. Radio frequency circuitry 325 may connect to transmit circuitry 315 and receive circuitry 320 via one or more radio chain interfaces 376 and/or a combined radio chain interface 378. In some aspects, one or more radio chain interfaces 376 may provide one or more interfaces to one or more receive or transmit signals, each associated with a single antenna structure. In some aspects, the combined radio chain interface 378 may provide a single interface to one or more receive or transmit signals, each associated with a group of antenna structures.

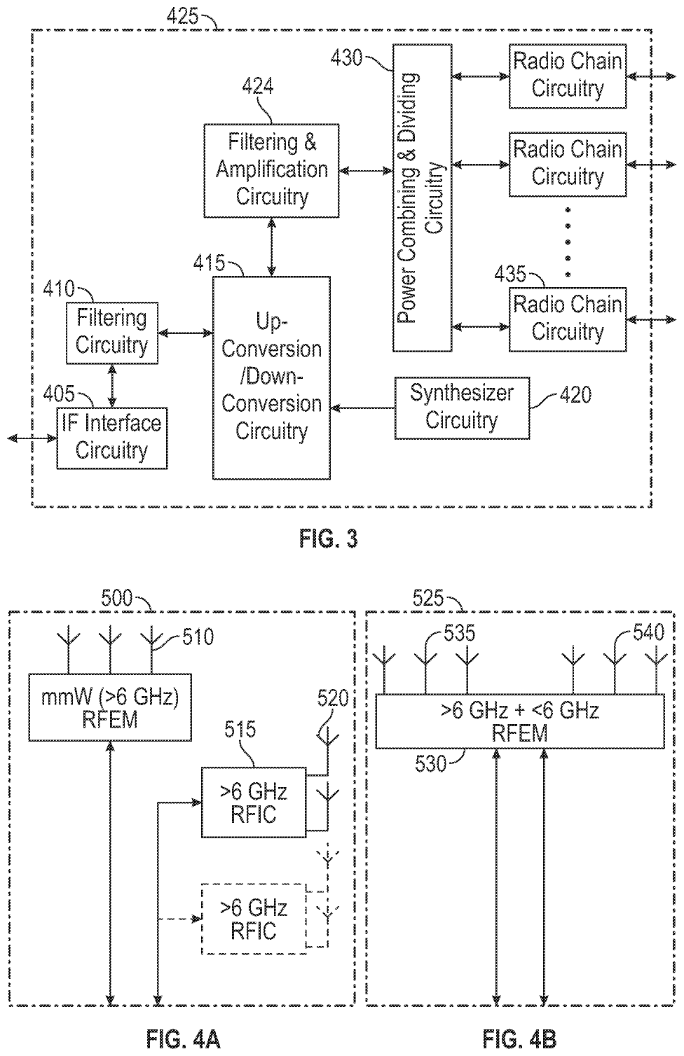

FIG. 3 illustrates exemplary RF circuitry of FIG. 2A according to some aspects. In an aspect, RF circuitry 325 in FIG. 2A (depicted in FIG. 3 using reference number 425) may include one or more of the IF interface circuitry 405, filtering circuitry 410, up-conversion and down-conversion circuitry 415, synthesizer circuitry 420, filtering and amplification circuitry 424, power combining and dividing circuitry 430, and radio chain circuitry 435.

FIG. 4A and FIG. 4B illustrate aspects of a radio front-end module (RFEM) useable in the circuitry shown in FIG. 1 and FIG. 3, according to some aspects. FIG. 4A illustrates an aspect of a RFEM according to some aspects.

RFEM 500 incorporates a millimeter wave RFEM and one or more above-six gigahertz radio frequency integrated circuits (RFIC) 515 and/or one or more sub-six gigahertz RFICs (not shown in FIG. 4A). In this aspect, the one or more sub-six gigahertz RFICs 515 and/or one or more sub-six gigahertz RFICs may be physically separated from millimeter wave RFEM. RFICs 515 may include connection to one or more antennas 520. RFEM may include multiple antennas 510.

FIG. 4B illustrates an alternate aspect of a radio front end module 525, according to some aspects. In this aspect both millimeter wave and sub-six gigahertz radio functions may be implemented in the same physical radio front end module (RFEM) 530. RFEM 530 may incorporate both millimeter wave antennas 535 and sub-six gigahertz antennas 540.

### Integrated Antenna Steering System

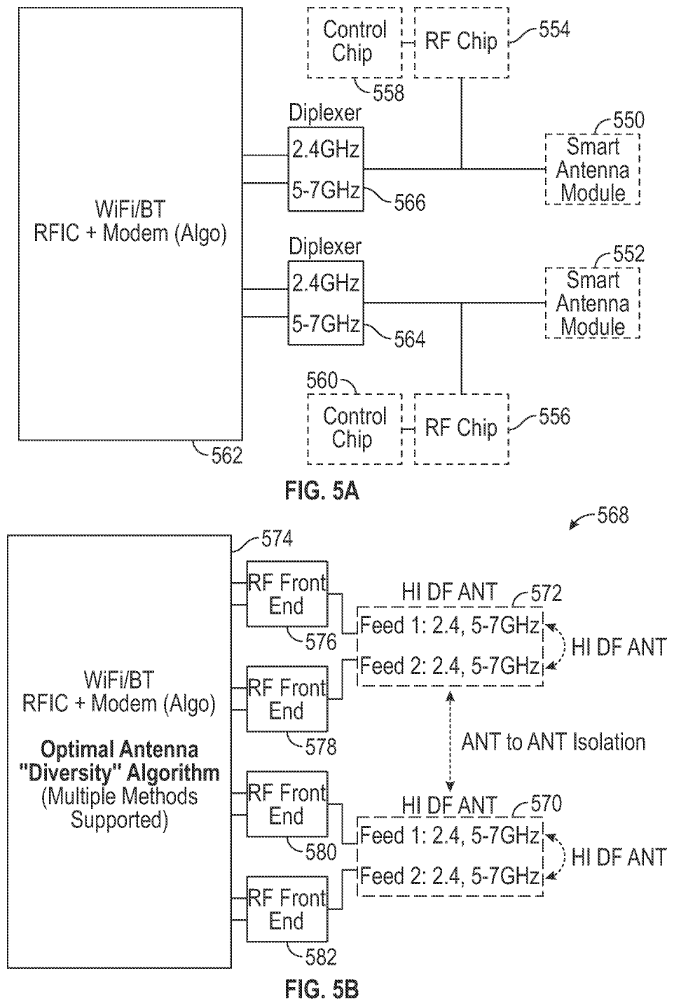

As described earlier herein, many devices used today include multiple antennas for communicating on a plurality of communication bands. FIG. 5A illustrates one available solution that provides antenna steering and other control options for higher-end devices or products. The solution shown in FIG. 5A provides antenna module/s 550, 552 (which can have incorporated control circuitry, algorithms, etc.). The solution shown in FIG. 5A can also include RF chips 554, 556, and control chips 558, 560. RFIC 562 can provide signals to the antenna modules through filters 564, 566 or other circuitry comprised of passive elements for diplexers or active elements (e.g. PA, LNA, Switch). However, control chips 558 & 560 will not have access to the communication information or conditions known only to RFIC 562. Furthermore, the additional circuitry shown in FIG. 5A (or other circuitry not shown that could be used for antenna control) adds expense and complexity to user devices.

Aspects of the disclosure address these and other concerns by providing a system 568 as shown in FIG. 5B. As seen in FIG. 5B, a system 568 according to aspects of the disclosure includes high-isolation dual feed (HI DF) antennas 570, 572 spaced to guarantee high isolation. The system 568 further includes connectivity circuitry 574. Connectivity circuitry 574 can include RFICs for communicating on a plurality of communication bands (e.g., Wi-Fi and Bluetooth or circuitry although aspects of the disclosure are not limited thereto) which can be similar to RFIC 515 (FIG. 4A)), in addition to modem circuitry or other circuitry. The connectivity circuitry 574 does not include separate dedicated antenna circuitry and as described below, systems and apparatuses in accordance with embodiments does not include dedicated antenna control circuitry or “smart” antenna modules.

The system 568 shown includes two dual feed antennas 570, 572, and four RF chains 576, 578, 580, 582 connected to antennas 570, 572, wherein the RF chains 576, 578, 580, 582 can include circuitry similar to radio chain circuitry 372 or other circuitry shown in FIG. 2A-2D described above. However, it will be understood that more than two antennas can be included, and the number of antenna feeds can be higher than dual feed (e.g., three-feed, four-feed or higher). The system 568 can provide dual radio support, antenna steering, and other capabilities as described herein. Feed-to-feed isolation is provided of at least 40 dB, which is greater than isolation needed for antenna steering. Antenna-to-antenna isolation is provided of at least 15 dB.

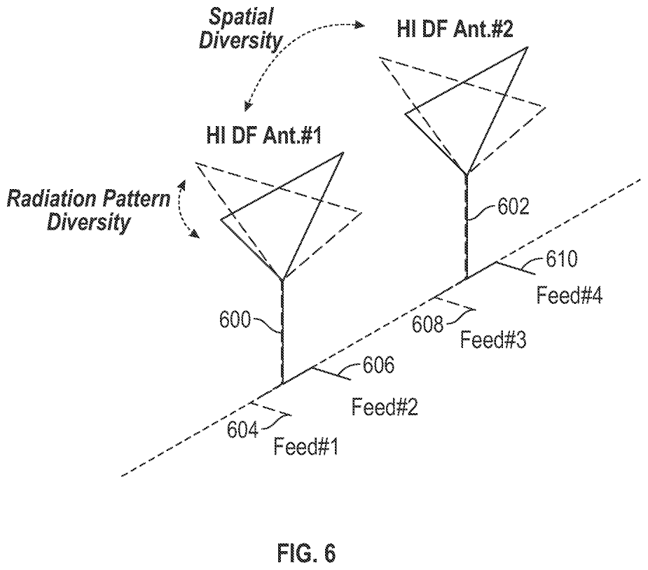

The example system 568 therefore effectively provides four diversity antennas (although aspects of the disclosure are not limited to four diversity antennas) as shown in FIG. 6. These antennas can provide various features. These features can include antenna selection, wherein one of the four (or more) can be selected in single-input-single-output (SISO) use cases and systems (see Equation (2) below.

Equation (1) shows how digital TX data streams within the modem (xₙ) can be multiplied by a complex spatial weight matrix (A) to create the four outputs going to the four TX RF chains (yₙ). Such a complex spatial weight matrix can be applied in the RX path as well.

$$[ \begin{matrix}{y}_{1} \\ {y}_{2} \\ {y}_{3} \\ {y}_{4}\end{matrix} ] = [ \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ {a}_{41} & {a}_{42} & {a}_{43} & {a}_{44}\end{matrix} ] [ \begin{matrix}{X}_{1} \\ {X}_{2} \\ {X}_{3} \\ {X}_{4}\end{matrix} ] \qquad ( 1 )$$

Equation 1 is of a generic form, and allows multiple antenna “diversity” features, in contrast to the system shown in FIG. 5A.

Antenna selection can be performed to select antennas, for example in Equation (2) in which two antennas (x₁ and x₄) are selected:

$$[ \begin{matrix}{y}_{1} \\ {y}_{2} \\ {y}_{3} \\ {y}_{4}\end{matrix} ] = [ \begin{matrix}1 & 0 & 0 & 0 \\ 0 & 0 & 0 & 0 \\ 0 & 0 & 0 & 0 \\ 0 & 0 & 0 & 1\end{matrix} ] [ \begin{matrix}{x}_{1} \\ {x}_{2} \\ {x}_{3} \\ {x}_{4}\end{matrix} ] = [ \begin{matrix}{x}_{1} \\ 0 \\ 0 \\ {x}_{4}\end{matrix} ] \qquad ( 2 )$$

Features provided in system 568 can also include polarization modulation/multiplexing and spatial modulation/multiplexing can be performed by providing a modem-optimized complex weight matrix. For example, a four-stream spatial code or weight matrix can be used to modulate the data in order to achieve higher throughput, or alternatively higher immunity to fading over the wireless channel.

Other features provided in system 568 according to some aspects of the disclosure include other weighted (magnitude/phase—can be frequency selective) combining in TX and RX (e.g., MRC), as shown in Equation (3):

$$[ \begin{matrix}{y}_{1} \\ {y}_{2} \\ {y}_{3} \\ {y}_{4}\end{matrix} ] = [ \begin{matrix}1 & 0 & 0 & 0 \\ 0 & 1 & 0 & 0 \\ α \cdot {e}^{j {θ}_{1}} \cdot {x}_{1} & 0 & 0 & 0 \\ 0 & β \cdot {e}^{j {θ}_{2}} \cdot {x}_{2} & 0 & 0\end{matrix} ] [ \begin{matrix}{x}_{1} \\ {x}_{2} \\ {x}_{3} \\ {x}_{4}\end{matrix} ] = [ \begin{matrix}{x}_{1} \\ {x}_{2} \\ α \cdot {e}^{j {θ}_{1}} \cdot {x}_{1} \\ β \cdot {e}^{j {θ}_{2}} \cdot {x}_{2}\end{matrix} ] \qquad ( 3 )$$

For example, the signals received from multiple antennas can be combined with optimal weights to maximize SNR and thus achieve higher throughput.

Nulling can also be performed in which antenna/s are selected to provide the highest nulling of interference, both from internal sources (self-blocker, platform noise) and external sources (blockers, obstacles).

The system 568 can also provide a performance advantage relative to available systems (of which the system shown in FIG. 5A is an example). In system 568, the connectivity circuitry 574 has access to information concerning actual/desired data rates; modulation schemes; bandwidths; noise and interference information (e.g., signal to noise ratio (SNR), received signal strength indication (RSSI), etc.); channel equalization and side information; Wi-Fi versus Bluetooth (BT) priority; etc. This and other information can be used for antenna 570, 572 steering decisions and other antenna controls. Systems similar to that shown in FIG. 5A make steering and other antenna decisions based on RF signals only, which is far more limited than the information that is available to the connectivity circuitry 574 of system 568.

Other information available to the connectivity circuitry 574 of system 568 can include information regarding Wi-Fi/BT co-running optimization. For example, the Wi-Fi and BT signals can be steered to the antennas that provide the least mutual interference (RX desensitization) per operating frequencies combination. Other information available to the connectivity circuitry 574 of system 568 can include internal (platform) and external interference. For example, the impact of the interference can be measured by connectivity circuitry 574 for several steering options and a steering option can be selected based on best SNR/interference level. In contrast, in the system shown in FIG. 5A, RFIC 562 performs optimizations based on RF power detection only with zero communication-related data, resulting in degradation of communication performance.

The connectivity circuitry 574 modem can digitally manipulate the magnitude and phase of each RF chain 576, 578, 580, 582 signal (stream), even in a frequency-selective manner and with very high resolution, thus implementing the best possible antenna “diversity” features. On the other hand, the system of FIG. 5A relies on RF chips 554, 556 which provide very limited, coarse and inaccurate phase control.

FIG. 6 illustrates two antennas 600, 602, each having two feeds 604, 606, 608, 610. Each antenna 600, 602 has high-isolation and furthermore has radiation pattern diversity as shown as well as spatial diversity. While two dual-feed antennas are shown, systems according to aspects of the disclosure can include multi-feed antennas with greater than two feeds.

In the above, high-isolation dual feed antenna systems are described wherein connectivity circuitry having information regarding communication parameters/conditions can control antenna steering, weighting and other aspects. This allows controllable antenna systems without the cost of additional complex and costly circuitry.

### Other Systems and Apparatuses

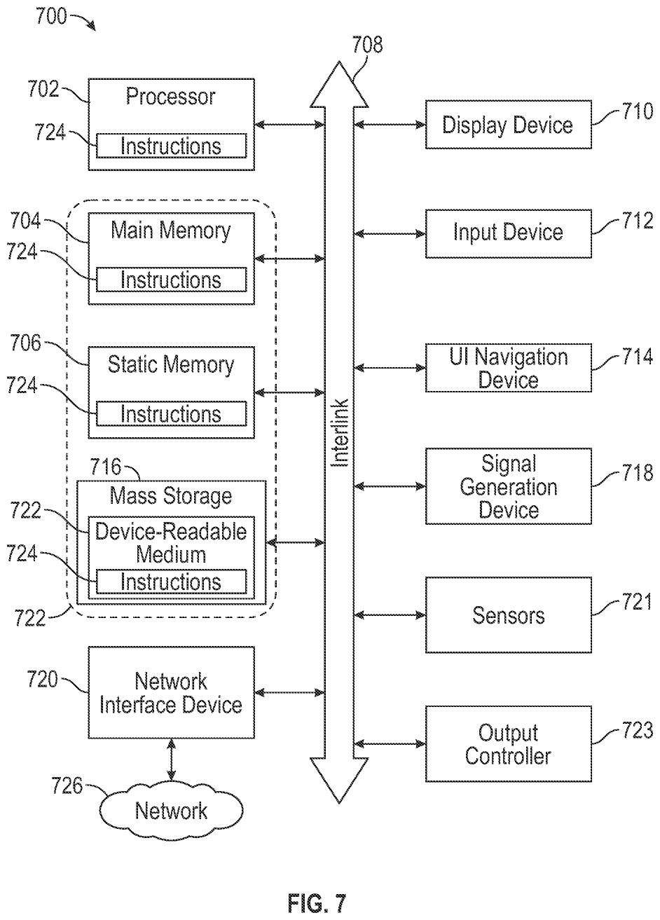

FIG. 7 illustrates a block diagram of a communication device 700 such as an evolved Node-B (eNB), a new generation Node-B (gNB), an access point (AP), a wireless station (STA), a mobile station (MS), or a user equipment (UE), in accordance with some aspects. In alternative aspects, the communication device 700 may operate as a standalone device or may be connected (e.g., networked) to other communication devices. In some aspects, the communication device 700 can use one or more of the techniques and circuits discussed herein, in connection with any of FIG. 1-FIG. 6.

Circuitry (e.g., processing circuitry) is a collection of circuits implemented in tangible entities of the device 700 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 700 follow.

In some aspects, the device 700 may operate as a standalone device or may be connected (e.g., networked) to other devices. In a networked deployment, the communication device 700 may operate in the capacity of a server communication device, a client communication device, or both in server-client network environments. In an example, the communication device 700 may act as a peer communication device in peer-to-peer (P2P) (or other distributed) network environment. The communication device 700 may be a UE, eNB, PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times.

Software may accordingly configure a hardware processor, for example, to constitute a particular module at one instance of time and to constitute a different module at a different instance of time.

Communication device (e.g., UE) 700 may include a hardware processor 702 (e.g., a central processing unit (CPU), a graphics processing unit (GPU), a hardware processor core, or any combination thereof), a main memory 704, a static memory 706, and mass storage 716 (e.g., hard drive, tape drive, flash storage, or other block or storage devices), some or all of which may communicate with each other via an interlink (e.g., bus) 708.

The communication device 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The communication device 700 may additionally include a signal generation device 718 (e.g., a speaker), a network interface device 720, and one or more sensors 721, such as a global positioning system (GPS) sensor, compass, accelerometer, or other sensor. The communication device 700 may include an output controller 723, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage 716 may include a communication device-readable medium 722, on which is stored one or more sets of data structures or instructions 724 (e.g., software) embodying or utilized by any one or more of the techniques or functions described herein. In some aspects, registers of the processor 702, the main memory 704, the static memory 706, and/or the mass storage 716 may be, or include (completely or at least partially), the device-readable medium 722, on which is stored the one or more sets of data structures or instructions 724, embodying or utilized by any one or more of the techniques or functions described herein. In an example, one or any combination of the hardware processor 702, the main memory 704, the static memory 706, or the mass storage 716 may constitute the device-readable medium 722.

As used herein, the term “device-readable medium” is interchangeable with “computer-readable medium” or “machine-readable medium.” While the communication device-readable medium 722 is illustrated as a single medium, the term “communication device-readable medium” may include a single medium or multiple media (e.g., a centralized or distributed database, and/or associated caches and servers) configured to store the one or more instructions 724.

The term “communication device-readable medium” may include any medium that is capable of storing, encoding, or carrying instructions for execution by the communication device 700 and that cause the communication device 700 to perform any one or more of the techniques of the present disclosure, or that is capable of storing, encoding or carrying data structures used by or associated with such instructions. Non-limiting communication device-readable medium examples may include solid-state memories, and optical and magnetic media. Specific examples of communication device-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), MIMO, or multiple-input single-output (MISO) techniques. In some examples, the network interface device 720 may wirelessly communicate using Multiple User MIMO techniques.

The term “transmission medium” shall be taken to include any intangible medium that is capable of storing, encoding, or carrying instructions for execution by the communication device 700, and includes digital or analog communications signals or other intangible medium to facilitate communication of such software. In this regard, a transmission medium in the context of this disclosure is a device-readable medium.

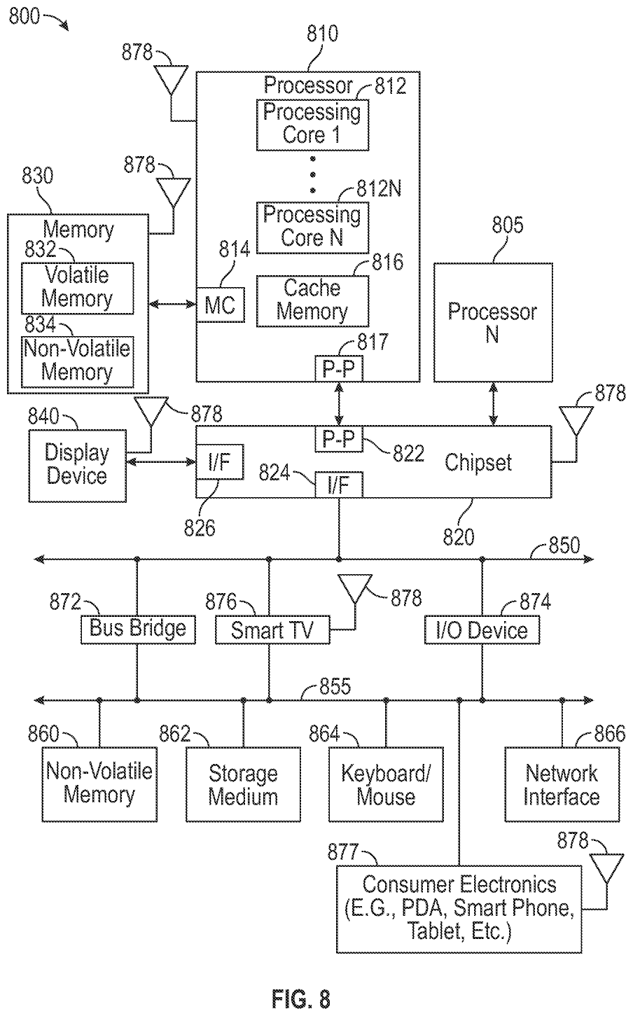

FIG. 8 illustrates a system level diagram, depicting an example of an electronic device (e.g., system) that can include, for example, a transmitter configured to selectively fan out a signal to one of multiple communication channels. FIG. 8 is included to show an example of a higher-level device application for the subject matter discussed above with regards to FIGS. 1-7. In one aspect, system 800 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance, or any other type of computing device. In some aspects, system 800 is a system on a chip (SOC) system.

In one aspect, processor 810 has one or more processor cores 812, . . . 812N, where 812N represents the Nth processor core inside processor 810 where N is a positive integer. In one aspect, system 800 includes multiple processors including 810 and 805, where processor 805 has logic similar or identical to the logic of processor 810. In some aspects, processing core 812 includes, but is not limited to, pre-fetch logic to fetch instructions, decode logic to decode the instructions, execution logic to execute instructions and the like. In some aspects, processor 810 has a cache memory 816 to cache instructions and/or data for system 800. Cache memory 816 may be organized into a hierarchal structure including one or more levels of cache memory.

In some aspects, processor 810 includes a memory controller 814, which is operable to perform functions that enable the processor 810 to access and communicate with memory 830 that includes a volatile memory 832 and/or a non-volatile memory 834. In some aspects, processor 810 is coupled with memory 830 and chipset 820. Processor 810 may also be coupled to a wireless antenna 878 to communicate with any device configured to transmit and/or receive wireless signals. In one aspect, an interface for wireless antenna 878 operates in accordance with, but is not limited to, the IEEE 802.11 standard and its related family, Home Plug AV (HPAV), Ultra Wide Band (UWB), Bluetooth, WiMax, or any form of wireless communication protocol.

In some aspects, volatile memory 832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 834 includes, but is not limited to, flash memory, phase change memory (PCM), read-only memory (ROM), electrically erasable programmable read-only memory (EEPROM), or any other type of non-volatile memory device.

Memory 830 stores information and instructions to be executed by processor 810. In one aspect, memory 830 may also store temporary variables or other intermediate information while processor 810 is executing instructions. In the illustrated aspect, chipset 820 connects with processor 810 via Point-to-Point (PtP or P-P) interfaces 817 and 822. Chipset 820 enables processor 810 to connect to other elements in system 800. In some aspects of the example system, interfaces 817 and 822 operate in accordance with a PtP communication protocol such as the Intel® QuickPath Interconnect (QPI) or the like. In other aspects, a different interconnect may be used.

In some aspects, chipset 820 is operable to communicate with processor 810, 805, display device 840, and other devices, including a bus bridge 872, a smart TV 876, I/O devices 874, nonvolatile memory 860, a storage medium (such as one or more mass storage devices) 862, a keyboard/mouse 864, a network interface 866, and various forms of consumer electronics 877 (such as a PDA, smart phone, tablet etc.), etc. In one aspect, chipset 820 couples with these devices through an interface 824. Chipset 820 may also be coupled to a wireless antenna 878 to communicate with any device configured to transmit and/or receive wireless signals.

Chipset 820 connects to display device 840 via interface 826. Display device 840 may be, for example, a liquid crystal display (LCD), a plasma display, cathode ray tube (CRT) display, or any other form of visual display device. In some aspects of the example system, processor 810 and chipset 820 are merged into a single SOC. In addition, chipset 820 connects to one or more buses 850 and 855 that interconnect various system elements, such as I/O devices 874, nonvolatile memory 860, storage medium 862, a keyboard/mouse 864, and network interface 866. Buses 850 and 855 may be interconnected together via a bus bridge 872.

In one aspect, storage medium 862 includes, but is not limited to, a solid-state drive, a hard disk drive, a universal serial bus flash memory drive, or any other form of computer data storage medium. In one aspect, network interface 866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one aspect, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 8 are depicted as separate blocks within the system 800, the functions performed by some of these blocks may be integrated within a single semiconductor circuit or may be implemented using two or more separate integrated circuits. For example, although cache memory 816 is depicted as a separate block within processor 810, cache memory 816 (or selected aspects of 816) can be incorporated into processor core 812.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “an example aspect,” “some aspects,” “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IoT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may, for example, be used in conjunction with devices and/or networks operating in accordance with existing IEEE 802.11 standards (including IEEE 802.11-2016 (IEEE 802.11-2016, IEEE Standard for Information technology—Telecommunications and information exchange between systems Local and metropolitan area networks—Specific requirements Part 11: Wireless LAN Medium Access Control (MAC) and Physical Layer (PHY) Specifications, Dec. 7, 2016); IEEE 802.11ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing Wi-Fi Alliance (WFA) Peer-to-Peer (P2P) specifications (including Wi-Fi P2P technical specification, version 1.5, Aug. 4, 2015) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting and/or the action of receiving. In one example, the phrase “communicating a signal” may refer to the action of transmitting the signal by a first device and may not necessarily include the action of receiving the signal by a second device. In another example, the phrase “communicating a signal” may refer to the action of receiving the signal by a first device and may not necessarily include the action of transmitting the signal by a second device.

Some demonstrative aspects may be used in conjunction with a wireless communication network communicating over a frequency band above 45 Gigahertz (GHz), e.g., 60 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a frequency band above 45 GHz, a frequency band below 20 GHz, e.g., a Sub 1 GHz (S1G) band, a 2.4 GHz band, a 5 GHz band, a WLAN frequency band, a WPAN frequency band, a frequency band according to the WGA specification, and the like.

As used herein, the term “circuitry” may, for example, refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, circuitry may include logic, at least partially operable in hardware. In some aspects, the circuitry may be implemented as part of and/or in the form of a radio virtual machine (RVM), for example, as part of a Radio processor (RP) configured to execute code to configured one or more operations and/or functionalities of one or more radio components.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna” or “antenna array,” as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

### Additional Notes and Aspects

Example 1 is a mobile device comprising a plurality of multi-feed antennas having high feed-to-feed isolation and high antenna-to-antenna isolation; radio frequency (RF) transceiver circuitry connected to the plurality of multi-feed antennas through passive circuit elements to form radio frequency RF chains; and connectivity circuitry coupled to the RF transceiver circuitry and configured to: detect communication-related data; and perform antenna control functions based on the communication-related data by providing a digital control signal to modify magnitude and phase of the RF chains.

In Example 2, the subject matter of Example 1 can include wherein the connectivity circuitry is configured to operate in two or more frequency bands, and wherein the mobile device does not include dedicated antenna control circuitry.

In Example 3, the subject matter of any of Examples 1-2 can optionally include wherein the antenna control functions include antenna selection.

In Example 4, the subject matter of any of Examples 1-3 can optionally include wherein the antenna control functions include polarization modulation or multiplexing.

In Example 5 the subject matter of any of Examples 1-4 can optionally include wherein the antenna control functions include spatial modulation or multiplexing.

In Example 6, the subject matter of any of Examples 1-5 can optionally include wherein the multi-feed antennas have feed-to-feed isolation of at least 40 dB.

In Example 7, the subject matter of any of Examples 1-6 can optionally include wherein the multi-feed antennas have antenna-to-antenna isolation of at least 15 dB.

In Example 8, the subject matter of any of Examples 1-7 can optionally include wherein the communication-related data includes one or more of: a modulation scheme, interference levels, or bandwidth.

Example 9 is an apparatus comprising one or more components of Examples 1-8.

Example 10 is a method for performing any operations described in any of Examples 1-8.

Example 11 is a system comprising means for performing any of Examples 1-8.

The above detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are legally entitled.

We claim:

1. A mobile device comprising:
a plurality of multi-feed antennas having high feed-to-feed isolation and high antenna-to-antenna isolation;
radio frequency (RF) transceiver circuitry connected to the plurality of multi-feed antennas through passive circuit elements to form radio frequency RF chains; and
connectivity circuitry coupled to the RF transceiver circuitry and configured to:
detect communication-related data; and
perform antenna control functions based on the communication-related data by providing a digital control signal to modify magnitude and phase of the RF chains.

2. The mobile device of claim 1, wherein the connectivity circuitry is configured to operate in two or more frequency bands, and wherein the mobile device does not include dedicated antenna control circuitry.

3. The mobile device of claim 1, wherein the antenna control functions include antenna selection.

4. The mobile device of claim 1, wherein the antenna control functions include polarization modulation or multiplexing.

5. The mobile device of claim 1, wherein the antenna control functions include spatial modulation or multiplexing.

6. The mobile device of claim 1 wherein the multi-feed antennas have feed-to-feed isolation of at least 40 dB.

7. The mobile device of claim 1 wherein the multi-feed antennas have antenna-to-antenna isolation of at least 15 dB.

8. The mobile device of claim 1 wherein the communication-related data includes one or more of:
a modulation scheme, interference levels, or bandwidth.

9. An apparatus comprising:
radio frequency (RF) transceiver circuitry connected to a plurality of multi-feed antennas through passive circuit elements to form RF chains; and
connectivity circuitry coupled to the RF transceiver circuitry and configured to:
detect communication-related data; and
perform antenna control functions based on the communication-related data by providing a digital control signal to modify magnitude and phase of the RF chains.

10. The apparatus of claim 9 wherein the communication-related data includes one or more of:
a modulation scheme, interference levels, or bandwidth.

11. The apparatus of claim 9, wherein the connectivity circuitry is configured to operate at two or more frequency bands.

12. The apparatus of claim 9, wherein the antenna control functions include antenna selection.

13. The apparatus of claim 9, wherein the antenna control functions include polarization modulation or multiplexing.

14. The apparatus of claim 9, wherein the antenna control functions include spatial modulation or multiplexing.

15. The apparatus of claim 9 wherein the multi-feed antennas have feed-to-feed isolation of at least 40 dB.

16. The apparatus of claim 9 wherein the multi-feed antennas have antenna-to-antenna isolation of at least 15 dB.

17. A computer-readable medium including instructions that, when executed on connectivity circuitry, cause the connectivity circuitry to perform operations including:
detecting communication-related data provided by multi-feed antennas having high feed-to-feed isolation and high antenna-to-antenna isolation; and
performing antenna control functions based on the communication-related data by providing a digital control signal to modify magnitude and phase of passive circuitry coupled to the multi-feed antennas.

18. The computer-readable medium of claim 17, wherein the communication-related data includes one or more of:
a modulation scheme, interference levels, or bandwidth.

19. The computer-readable medium of claim 17, wherein the antenna control functions include antenna selection.

20. The computer-readable medium of claim 17, wherein the antenna control functions include polarization modulation or multiplexing.
